(19) United States
(12) Patent Application Publication
(10) Pub. No.: US 2025/0329978 A1
(43) Pub. Date: Oct. 23, 2025

(54) CHAMBER APPARATUS FOR LASER, GAS LASER APPARATUS, AND ELECTRONIC DEVICE MANUFACTURING METHOD

(71) Applicant: Gigaphoton Inc., Tochigi (JP)

(72) Inventors: Takahiro TATSUMI, Oyama-shi (JP); Noriyuki WATANABE, Oyama-shi (JP)

(73) Assignee: Gigaphoton Inc., Tochigi (JP)

(21) Appl. No.: 19/258,388

(22) Filed: Jul. 2, 2025

Related U.S. Application Data
(63) Continuation of application No. PCT/JP2023/006855, filed on Feb. 24, 2023.

(51) Int. Cl. H01S 3/036; H01S 3/038; H01S 3/225

(52) U.S. Cl. CPC H01S 3/036; H01S 3/038; H01S 3/2251

(57) ABSTRACT

A chamber apparatus for a laser includes a chamber, first and second discharge electrodes, a fan, and a return member. The chamber includes a chamber body and an insulating plate. The chamber has an internal space filled with a laser gas. The first and second discharge electrodes are disposed in the internal space. The fan causes the laser gas to flow between the first and second discharge electrodes. The return member is provided upstream of the second discharge electrode in a flow of the laser gas. The return member includes a ladder section and a plate-shaped section. The ladder section includes multiple linear portions. The plate-shaped section is connected to the multiple linear portions. The plate-shaped section is inclined such that the further the return member is away from the top wall, the more downstream the return member is in the flow of the laser gas.

### CROSS-REFERENCE TO RELATED APPLICATIONS

The present application is a continuation application of International Application No. PCT/JP2023/006855, filed on Feb. 24, 2023, the entire contents of which are hereby incorporated by reference.

### BACKGROUND

### 1. Technical Field

The present disclosure relates to a chamber apparatus for a laser, a gas laser apparatus, and an electronic device manufacturing method.

### 2. Related Art

In recent years, a semiconductor exposure apparatus is required to improve the resolution thereof as semiconductor integrated circuits are increasingly miniaturized and highly integrated. To this end, reduction in the wavelength of light emitted from a light source for exposure is underway. For example, a KrF excimer laser apparatus, which outputs laser light having a wavelength of about 248 nm, and an ArF excimer laser apparatus, which outputs laser light having a wavelength of about 193 nm, are used as a gas laser apparatus for exposure.

The light from KrF and ArF excimer laser apparatuses undergoing spontaneous laser oscillation has a wide spectral linewidth ranging from 350 μm to 400 pm. A projection lens made of a material that transmits ultraviolet light, such as KrF and ArF laser light, therefore produces chromatic aberrations in some cases. As a result, the resolution of the projection lens may decrease. To avoid the decrease in the resolution, the spectral linewidth of the laser light output from the gas laser apparatus needs to be narrow enough to make the chromatic aberrations negligible. To this end, a line narrowing module (LNM) including a line narrowing element (such as etalon or grating) is provided in some cases in a laser resonator of the gas laser apparatus to narrow the spectral linewidth. A gas laser apparatus providing a narrowed spectral linewidth is hereinafter referred to as a narrowed-line gas laser apparatus.

### CITATION LIST

### Patent Literature

PTL 1: JP-A-64-053588
PTL 2: JP-A-5-243645

### SUMMARY

A chamber apparatus for a laser according to an aspect of the present disclosure is a chamber apparatus for a laser configured to output laser light by exciting a laser gas with an aid of discharge. The chamber apparatus may include a chamber, a first discharge electrode, a second discharge electrode, a fan, and a return member. The chamber includes an electrically conductive chamber body and an insulating plate. The electrically conductive chamber body has an opening provided at a top wall of the chamber body. The insulating plate closes the opening. The chamber has an internal space filled with the laser gas. The first discharge electrode is disposed on an internal space side of the insulating plate. The second discharge electrode is disposed so as to face the first discharge electrode in the internal space. The fan is configured to cause the laser gas to flow between the first discharge electrode and the second discharge electrode in a direction perpendicular to an optical axis of the laser light. The return member is provided upstream of the second discharge electrode in a flow of the laser gas. The return member electrically connects the second discharge electrode to the chamber body. The return member has an end opposite to the second discharge electrode and connected to the top wall. The return member includes a ladder section and a plate-shaped section. The ladder section includes multiple linear portions arranged next to each other along the optical axis. The plate-shaped section is provided on a top wall side of the return member. The plate-shaped section is connected to the multiple linear portions. The plate-shaped section is inclined such that the further the plate-shaped section is away from the top wall, the more downstream the plate-shaped section is in the flow of the laser gas.

A gas laser apparatus according to another aspect of the present disclosure is a gas laser apparatus including a chamber apparatus for a laser. The chamber apparatus is configured to output laser light by exciting a laser gas with an aid of discharge. The chamber apparatus for a laser may include a chamber, a first discharge electrode, a second discharge electrode, a fan, and a return member. The chamber includes an electrically conductive chamber body and an insulating plate. The electrically conductive chamber body has an opening provided at a top wall of the chamber body. The insulating plate closes the opening. The chamber has an internal space filled with the laser gas. The first discharge electrode is disposed on an internal space side of the insulating plate. The second discharge electrode is disposed so as to face the first discharge electrode in the internal space. The fan is configured to cause the laser gas to flow between the first discharge electrode and the second discharge electrode in a direction perpendicular to an optical axis of the laser light. The return member is provided upstream of the second discharge electrode in a flow of the laser gas. The return member electrically connects the second discharge electrode to the chamber body. The return member has an end opposite to the second discharge electrode and connected to the top wall. The return member includes a ladder section and a plate-shaped section. The ladder section includes multiple linear portions arranged next to each other along the optical axis. The plate-shaped section is provided on a top wall side of the return member. The plate-shaped section is connected to the multiple linear portions. The plate-shaped section is inclined such that the further the plate-shaped section is away from the top wall, the more downstream the plate-shaped section is in the flow of the laser gas.

An electronic device manufacturing method according to another aspect of the present disclosure may include: generating laser light by using a gas laser apparatus including a chamber apparatus for a laser, the chamber apparatus being configured to output the laser light by exciting a laser gas with an aid of discharge; outputting the laser light to an exposure apparatus; and exposing a photosensitive substrate to the laser light in the exposure apparatus to manufacture electronic devices. The chamber apparatus for a laser includes a chamber, a first discharge electrode, a second discharge electrode, a fan, and a return member. The chamber including an electrically conductive chamber body and an insulating plate. The electrically conductive chamber body has an opening provided at a top wall of the chamber body. The insulating plate closes the opening, the chamber having an internal space filled with the laser gas. The first discharge electrode is disposed on an internal space side of the insulating plate. The second discharge electrode is disposed so as to face the first discharge electrode in the internal space. The fan is configured to cause the laser gas to flow between the first discharge electrode and the second discharge electrode in a direction perpendicular to an optical axis of the laser light. The return member is provided upstream of the second discharge electrode in a flow of the laser gas. The return member electrically connects the second discharge electrode to the chamber body. The return member has an end opposite to the second discharge electrode and connected to the top wall. The return member includes a ladder section and a plate-shaped section. The ladder section includes multiple linear portions arranged next to each other along the optical axis. The plate-shaped section is provided on a top wall side of the return member. The plate-shaped section is connected to the multiple linear portions. The plate-shaped section is inclined such that the further the plate-shaped section is away from the top wall, the more downstream the plate-shaped section is in the flow of the laser gas.

### BRIEF DESCRIPTION OF DRAWINGS

Embodiments of the present disclosure will be described below only by way of example with reference to the accompanying drawings.

FIG. 1 is a diagrammatic view showing a schematic configuration example of an entire electronic device manufacturing apparatus.

FIG. 2 is a diagrammatic view showing a schematic configuration example of an entire gas laser apparatus according to Comparative Example.

FIG. 3 is a cross-sectional view of a chamber apparatus according to Comparative Example taken along a plane perpendicular to an optical axis of laser light.

FIG. 4 shows a return member.

FIG. 5 shows a flow of a gas.

FIG. 6 shows a return member in a first embodiment.

FIG. 7 is a cross-sectional view of a chamber apparatus according to the first embodiment taken along a plane perpendicular to an optical axis of laser light.

FIG. 8 shows a return member in a second embodiment.

FIG. 9 is a cross-sectional view of a chamber apparatus according to the second embodiment taken along a plane perpendicular to an optical axis of laser light.

FIG. 10 is a cross-sectional view of a chamber apparatus according to a variation of the second embodiment taken along a plane perpendicular to an optical axis of laser light.

FIG. 11 is a cross-sectional view showing a return member in a third embodiment.

FIG. 12 is a cross-sectional view showing a return member according to a variation of the third embodiment.

### DETAILED DESCRIPTION

1. Description of electronic device manufacturing apparatus used in electronic device exposure step

### 2. Description of Comparative Example

### 2.1 Configuration

### 2.2 Operation

### 2.3 Problems

3. Description of first embodiment

### 3.1 Configuration

3.2 Effects and advantages
4. Description of second embodiment

### 4.1 Configuration

4.2 Effects and advantages

### 4.3 Variations

5. Description of third embodiment

### 5.1 Configuration

5.2 Effects and advantages

### 5.3 Variations

Embodiments of the present disclosure will be described below in detail with reference to the drawings. The embodiments described below show some examples of the present disclosure and are not intended to limit the contents of the present disclosure. Furthermore, all configurations and operations described in the embodiments are not necessarily essential as configurations and operations in the present disclosure. The same elements have the same reference characters, and no redundant description of the same elements will be made.

### 1. Description of Electronic Device Manufacturing Apparatus Used in Electronic Device Exposure Step

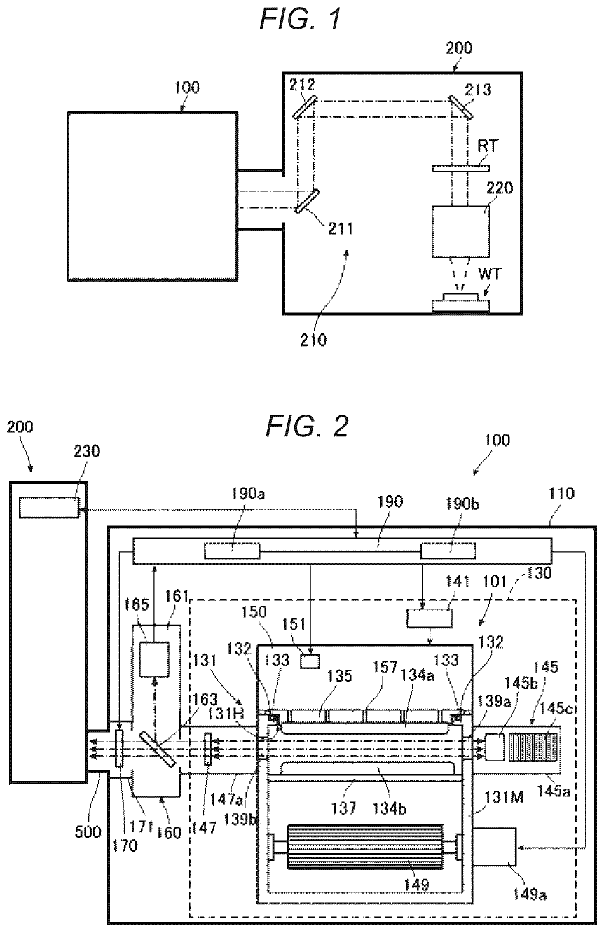

FIG. 1 is a diagrammatic view showing a schematic configuration example of an entire electronic device manufacturing apparatus used in an electronic device exposure step. The manufacturing apparatus used in the exposure step includes a gas laser apparatus 100 and an exposure apparatus 200, as shown in FIG. 1. The exposure apparatus 200 includes an illumination optical system 210, which includes multiple mirrors 211, 212, and 213, and a projection optical system 220. The illumination optical system 210 illuminates a reticle pattern on a reticle stage RT with laser light incident thereon from the gas laser apparatus 100. The projection optical system 220 performs reduction projection on the laser light having passed through the reticle to bring the laser light into focus on a workpiece that is not shown but is placed on a workpiece table WT. The workpiece is a photosensitive substrate, such as a semiconductor wafer onto which a photoresist has been applied. The exposure apparatus 200 translates the reticle stage RT and the workpiece table WT in synchronization with each other to expose the workpiece to the laser light having reflected the reticle pattern. Semiconductor devices that are electronic devices can be manufactured by transferring a device pattern onto the semiconductor wafer in the exposure step described above.

### 2. Description of Comparative Example

### 2.1 Configuration

The gas laser apparatus 100 according to Comparative Example will be described. Note that Comparative Example in the present disclosure is a form that the applicant is aware of as known only by the applicant, and is not a publicly known example that the applicant is self-aware of.

FIG. 2 is a diagrammatic view showing a schematic configuration example of the entire gas laser apparatus 100 according to Comparative Example. The gas laser apparatus 100 is an ArF excimer laser apparatus using a mixture gas containing, for example, argon (Ar), fluorine (F₂), and neon (Ne). The gas laser apparatus 100 outputs laser light having a center wavelength of about 193 nm. Note that the gas laser apparatus 100 may instead be a gas laser apparatus other than the ArF excimer laser apparatus, for example, a KrF excimer laser apparatus using a mixture gas containing krypton (Kr), F₂, and Ne. In this case, the gas laser apparatus 100 outputs laser light having a center wavelength of about 248 nm. The mixture gas containing Ar, F₂, and Ne, which are laser media, and the mixture gas containing Kr, F₂, and Ne, which are laser media, are each called a laser gas in some cases.

The gas laser apparatus 100 includes as primary elements an enclosure 110, a laser oscillator 130, a monitor module 160, a shutter 170, and a laser processor 190, the latter four of which are disposed in the internal space of the enclosure 110, as shown in FIG. 2. In the following description, the left side and the right side of the plane of view along the laser light traveling direction may be referred to as a front side and a rear side, respectively, and the upper side and the lower side of the plane of view may be referred to as an upper side and a lower side, respectively.

The laser oscillator 130 includes a chamber apparatus for a laser 101, a charger 141, a line narrowing module 145, an output coupling mirror 147, and a pulse compression circuit 150 as primary elements. Note in the following description that the chamber apparatus for a laser 101 is simply referred to as a chamber apparatus 101 in some cases. FIG. 2 shows the internal configuration of the chamber apparatus 101 in a cross-sectional view taken along a plane containing the optical axis of the laser light.

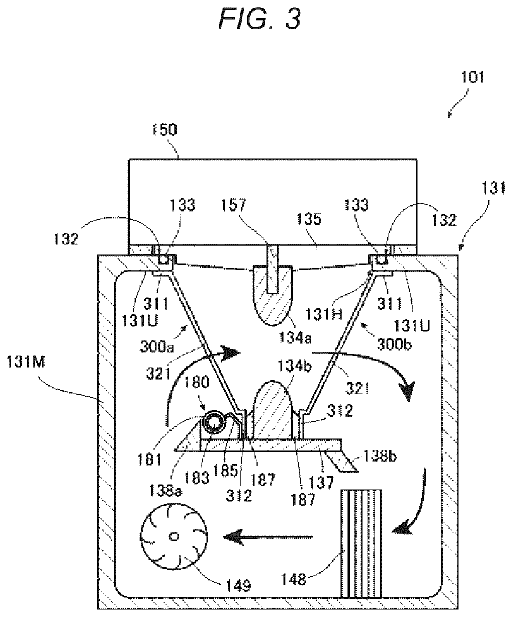

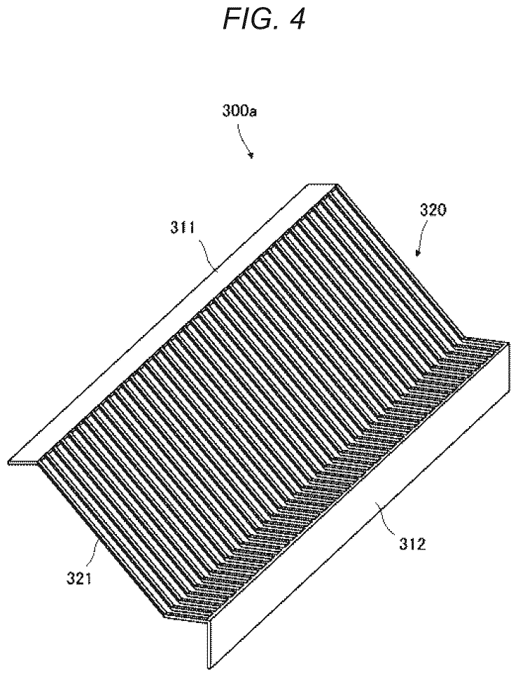

FIG. 3 is a cross-sectional view of the chamber apparatus 101 taken along a plane perpendicular to the optical axis of the laser light. The chamber apparatus 101 includes a discharge chamber 131. The discharge chamber 131 encloses an internal space where the laser medium in the laser gas is excited by discharge that will be described later to generate light. The discharge chamber 131 of the chamber apparatus 101 in the present example includes a chamber body 131M and an electrically insulating plate 135 serving as a lid, as shown in FIGS. 2 and 3. The chamber body 131M is made of an electrically conductive material, for example, nickel-plated aluminum or nickel-plated stainless steel.

An opening 131H is provided in a top wall 131U of the chamber body 131M. The opening 131H is closed by the electrically insulating plate 135. Specifically, a metal seal 133 is disposed in a groove 132 formed at the upper surface of the chamber body 131M, and is so pressed by the electrically insulating plate 135 that the metal seal 133 is deformed. The metal seal 133 therefore prevents formation of a gap between the chamber body 131M and the electrically insulating plate 135. The chamber body 131M and the electrically insulating plate 135 are thus combined with each other to enclose the internal space of the discharge chamber 131. The internal space is filled with the laser gas.

The electrically insulating plate 135 contains an insulator. The electrically insulating plate 135 may be made, for example, of an alumina ceramic material, which has low reactivity with F₂ gas. Note that the electrically insulating plate 135 only needs to be electrically insulating, and examples of the material of the thus functioning electrically insulating plate 135 may include resin such as phenol resin and fluororesin, quartz, and glass.

In the internal space of the discharge chamber 131, a first discharge electrode 134a and a second discharge electrode 134b are disposed so as to face each other with a distance therebetween, and the longitudinal direction of each of the electrodes extends along a predetermined direction that is the direction of the optical axis of the laser light. In the present example, the first discharge electrode 134a is located directly above the second discharge electrode 134b. The first discharge electrode 134a and the second discharge electrode 134b are electrodes that produce glow discharge to excite the laser medium. In the present example, the first discharge electrode 134a is the cathode, and the second discharge electrode 134b is the anode.

The second discharge electrode 134b is supported by an electrically conductive ground plate 137 and is electrically connected to the ground plate 137. Spacers 187 are fixed to the both sides of the second discharge electrode 134b in a direction perpendicular to the longitudinal direction thereof. The spacers 187 are made of an electrically conductive material and electrically connected to the ground plate 137 and the second discharge electrode 134b. The spacers 187 may be made, for example, of porous nickel that has low reactivity with the laser gas. A return member 300a is connected to a side of one of the spacers 187 that is the side opposite to the second discharge electrode 134b, and a return member 300b is connected to a side of the other spacer 187 that is the side opposite to the second discharge electrode 134b. The return members 300a and 300b are electrically conductive members. The return members 300a and 300b are therefore electrically connected to the second discharge electrode 134b. An end of the return member 300a that is the end opposite to the second discharge electrode 134b is connected to a portion adjacent to the opening 131H in the top wall 131U of the chamber body 131M. An end of the return member 300b that is the end opposite to the second discharge electrode 134b is connected to a portion adjacent to the opening 131H in the top wall 131U of the chamber body 131M that is a portion opposite to the portion to which the return member 300a is connected. The return members 300a and 300b therefore electrically connect the second discharge electrode 134b to the chamber body 131M. The chamber body 131M is electrically connected to the ground. The second discharge electrode 134b is therefore electrically connected to the ground via the spacers 187, the ground plate 137, the return members 300a and 300b, and the chamber body 131M. The return members 300a and 300b are preferably made of a material that is unlikely to chemically react with the laser gas, and examples of such electrically conductive materials may include copper and nickel.

The first discharge electrode 134a is fixed to a surface of the electrically insulating plate 135 that is closer to the internal space of the discharge chamber 131 via a current introducing terminal 157, which is, for example, configured with a bolt. The first discharge electrode 134a is therefore insulated from the chamber body 131M. The current introducing terminal 157 is electrically connected to the pulse compression circuit 150 and other circuit parts, and ensures electrical continuity between the pulse compression circuit 150 and the first discharge electrode 134a.

The charger 141 is a high-voltage DC power supply that supplies the pulse compression circuit 150 with electric energy. A switch 151 is electrically connected to the charger 141 and controlled by the laser processor 190. When the switch 151 transitions from the off-state to the on-state, the electric energy from the charger 141 is supplied to the pulse compression circuit 150. The pulse compression circuit 150 generates a pulse-shaped high voltage from the electric energy stored in the charger 141, and applies the high voltage to the first discharge electrode 134a.

When the high voltage is applied to the first discharge electrode 134a, discharge occurs between the first discharge electrode 134a and the second discharge electrode 134b due to a difference in potential between the first discharge electrode 134a and the second discharge electrode 134b. The energy of the discharge excites the laser medium in the discharge chamber 131, and the excited laser medium emits light when transitioning to the ground state.

A preliminary ionization electrode 180 is provided on the ground plate 137 and alongside one side of the second discharge electrode 134b via the spacer 187 and an end portion of the return member 300a. The preliminary ionization electrode 180 includes a dielectric pipe 181, a preliminary ionization inner electrode 183, and a preliminary ionization outer electrode 185.

The dielectric pipe 181 is so disposed that the longitudinal direction thereof coincides with the longitudinal direction of the second discharge electrode 134b, and is, for example, a cylindrical pipe. The dielectric pipe 181 is made, for example, of alumina ceramic or sapphire. The preliminary ionization inner electrode 183 is a rod-shaped electrode, is disposed inside the dielectric pipe 181, and extends along the longitudinal direction of the dielectric pipe 181. The preliminary ionization inner electrode 183 is made, for example, of copper or brass. The preliminary ionization outer electrode 185 is disposed between the dielectric pipe 181 and the second discharge electrode 134b, extends along the longitudinal direction of the dielectric pipe 181, and is fixed to the spacer 187. An end of the preliminary ionization outer electrode 185 is in contact with the outer circumferential surface of the dielectric pipe 181. Note that as long as corona discharge, which will be described later, occurs, at least a portion of the end of the preliminary ionization outer electrode 185 does not need to be in contact with the outer circumferential surface of the dielectric pipe 181.

The preliminary ionization inner electrode 183 is electrically connected to the pulse compression circuit 150 via a preliminary ionization capacitor that is not shown. The preliminary ionization outer electrode 185 is electrically connected to the second discharge electrode 134b via the ground plate 137, and is also electrically connected to the chamber body 131M via the ground plate 137 and the return members 300a and 300b. The preliminary ionization outer electrode 185 is therefore electrically connected to the ground. When the high voltage is applied to the preliminary ionization inner electrode 183 and the preliminary ionization outer electrode 185 from the pulse compression circuit 150, corona discharge occurs in the vicinity of the end of the preliminary ionization outer electrode 185. The corona discharge assists stable generation of glow discharge that occurs between the first discharge electrode 134a and the second discharge electrode 134b.

A stabilizer 138a is provided at a side surface of the ground plate 137 that is the surface located on the side where the return member 300a is provided. Furthermore, a guide 138b is provided at a lower surface of the ground plate 137 and on the side where the return member 300b is provided. The stabilizer 138a and the guide 138b are members that rectify the flow of the laser gas in such a way that the laser gas flows in an appropriate direction.

A crossflow fan 149 and a heat exchanger 148 are disposed in the internal space of the discharge chamber 131 and on a side of the ground plate 137 that is the side opposite to the second discharge electrode 134b. The space of the discharge chamber 131 where the crossflow fan 149 and the heat exchanger 148 are disposed communicates with the space between the second discharge electrode 134b and the first discharge electrode 134a. The heat exchanger 148 is a radiator that is disposed alongside the crossflow fan 149 and connected to a pipe which is not shown but through which a cooling medium flows. The crossflow fan 149 is connected to a motor 149a disposed outside the discharge chamber 131 as shown in FIG. 2, and rotated by the rotation produced by the motor 149a. When the crossflow fan 149 rotates, the laser gas with which the internal space of the discharge chamber 131 is filled circulates as indicated by the arrows in FIG. 3. That is, the crossflow fan 149 causes the laser gas to flow between the first discharge electrode 134a and the second discharge electrode 134b in the direction substantially perpendicular to the optical axis of the laser light. The laser gas flows as described above, so that the return member 300a is provided upstream in the flow of the laser gas, and the return member 300b is provided downstream in the flow of the laser gas. At least part of the circulating laser gas passes through the heat exchanger 148, which adjusts the temperature of the laser gas.

The laser gas is supplied from a laser gas supply source that is not shown via a pipe that is not shown. The laser gas in the discharge chamber 131 is caused to flow through a halogen filter that removes the F₂ gas from the laser gas or is otherwise treated, and the removed F₂ gas is exhausted by an exhaust pump that is not shown into the enclosure 110 through a pipe that is not shown.

The wall surface of the discharge chamber 131 is provided with a pair of windows 139a and 139b. The window 139a is located at one end of the discharge chamber 131 in the traveling direction of the laser light, and the window 139b is located at the other end of the discharge chamber 131 in the traveling direction, so that the windows 139a and 139b sandwich the space between the first discharge electrode 134a and the second discharge electrode 134b. The windows 139a and 139b may each incline with respect to the traveling direction of the laser light by Brewster's angle, so that reflection of the laser light at the windows is suppressed. The oscillating laser light exits out of the discharge chamber 131 via the windows 139a and 139b, as will be described later. Since the pulse compression circuit 150 applies the pulse-shaped high voltage to the space between the first discharge electrode 134a and the second discharge electrode 134b as described above, the laser light is pulse laser light.

The line narrowing module 145 includes an enclosure 145a, a prism 145b, a grating 145c, and a rotary stage that is not shown, the latter three of which are disposed in the internal space of the enclosure 145a. The enclosure 145a is provided with an opening, and is connected via the opening to the rear side of the discharge chamber 131.

The prism 145b increases the beam width of the light output via the window 139a and causes the expanded light to be incident on the grating 145c. Furthermore, the prism 145b reduces the beam width of the light reflected off the grating 145c and causes the resultant light to return into the internal space of the discharge chamber 131 via the window 139a. The prism 145b is supported and rotated by the rotary stage. The rotation of the prism 145b can change the angle of incidence of the light to be incident on the grating 145c to select a wavelength of the light that returns from the grating 145c to the discharge chamber 131 via the prism 145b. FIG. 2 shows a case where one prism 145b is disposed, and at least one prism only needs to be disposed.

The surface of the grating 145c is made of a high reflectance material, and a large number of grooves are provided at the surface at predetermined intervals. The grooves each have, for example, a right triangular cross-sectional shape. When the light incident from the prism 145b on the grating 145c is reflected off the grooves, the light is diffracted in the direction according to the wavelength of the light. The grating 145c is disposed in the Littrow arrangement, which causes the angle of incidence of the light incident from the prism 145b on the grating 145c to be equal to the angle of diffraction of the diffracted light having a desired wavelength. Light having the desired wavelength and wavelengths therearound thus returns to the discharge chamber 131 via the prism 145b.

The output coupling mirror 147 is disposed in the internal space of an optical path tube 147a connected to the front side of the discharge chamber 131, and faces the window 139b. The output coupling mirror 147 transmits part of the laser light output via the window 139b toward the monitor module 160, and reflects the other part of the laser light to cause the light to return into the internal space of the discharge chamber 131 via the window 139b. The grating 145c and the output coupling mirror 147 thus constitute a Fabry-Perot laser resonator.

The monitor module 160 is disposed in the optical path of the laser light output via the output coupling mirror 147. The monitor module 160 includes an enclosure 161, a beam splitter 163, and a photosensor 165, the latter two of which are disposed in the internal space of the enclosure 161. The enclosure 161 is provided with an opening, and the internal space of the enclosure 161 communicates via the opening with the internal space of the optical path tube 147a.

The beam splitter 163 transmits part of the laser light output via the output coupling mirror 147 toward the shutter 170, and reflects the other part of the laser light toward the light receiving surface of the photosensor 165. The photosensor 165 outputs a signal representing energy E of the laser light incident on the light receiving surface to the laser processor 190.

The laser processor 190 in the present disclosure is a processing apparatus including a storage 190a, which stores a control program, and a CPU (central processing unit) 190b, which executes the control program. The laser processor 190 is particularly configured or programmed to carry out various processes described in the present disclosure. The laser processor 190 further controls the entire gas laser apparatus 100.

The laser processor 190 transmits and receives various signals to and from an exposure processor 230 of the exposure apparatus 200. For example, the laser processor 190 receives from the exposure processor 230 signals representing a light emission trigger Tr, which will be described later, and target energy Et, and other pieces of information. The target energy Et is a target value of the energy of the laser light used in the exposure step. The laser processor 190 controls a charging voltage that charges the charger 141 based on the energy E received from the photosensor 165 and the target energy Et received from the exposure processor 230. Controlling the charging voltage controls the energy of the laser light. Furthermore, the laser processor 190 is electrically connected to the shutter 170 and controls the operation of opening and closing the shutter 170.

The light emission trigger Tr is a timing signal or an external trigger, and in response to the light emission trigger Tr, the exposure processor 230 causes the laser oscillator 130 to perform the laser oscillation. The light emission trigger Tr may be specified by a predetermined repetition frequency f of the laser light and a predetermined number of pulses P. The repetition frequency f of the laser light is, for example, higher than or equal to 100 Hz but lower than or equal to 10 KHz.

The shutter 170 is disposed in the optical path of the laser light in the internal space of an optical path tube 171, which communicates with an opening formed at a side of the enclosure 161 of the monitor module 160 that is the side opposite to the side to which the optical path tube 147a is connected. The internal spaces of the optical path tubes 171 and 147a, and the internal spaces of the enclosures 161 and 145a are filled with a purge gas supplied thereto. The purge gas contains an inert gas such as nitrogen (N₂). The purge gas is supplied from a purge gas supply source that is not shown via a pipe that is not shown. The optical path tube 171 communicates with the exposure apparatus 200 via an opening of the enclosure 110 and an optical path tube 500, which connects the enclosure 110 and the exposure apparatus 200 to each other. The laser light having passed through the shutter 170 enters the exposure apparatus 200.

The exposure processor 230 in the present disclosure is a processing apparatus including a storage that stores a control program, and a CPU that executes the control program. The exposure processor 230 is particularly configured or programmed to carry out various processes described in the present disclosure. The exposure processor 230 further controls the entire exposure apparatus 200.

The configurations of the return members 300a and 300b will next be described.

In the present example, the return members 300a and 300b have the same configuration, and only the return member 300a will therefore be described. FIG. 4 shows the return member 300a. The return member 300a is formed by punching and bending a single metal plate, and includes a plate-shaped first fixing section 311, a plate-shaped second fixing section 312, and a ladder section 320 connected to the first fixing section 311 and the second fixing section 312, as shown in FIG. 4. The metal plate to be punched and bent has a thickness ranging, for example, from 1.0 mm to 1.2 mm.

The first fixing section 311 is a member having a substantially rectangular principal surface, and is attached to the top wall 131U of the chamber body 131M with the longitudinal direction of the first fixing section 311 aligned with the longitudinal direction of the first discharge electrode 134a. The second fixing section 312 is shaped in a substantially same manner as the first fixing section 311, and attached to the spacer 187 with the longitudinal direction of the second fixing section 312 aligned with the longitudinal direction of the second discharge electrode 134b.

The ladder section 320 is configured with multiple linear portions 321 arranged next to each other. The linear portions 321 each have a width of, for example, approximately 1.0 mm. One end of each of the linear portions 321 is connected to the first fixing section 311, and the other end is connected to the second fixing section 312. In the present example, the return member 300a is formed by punching a single metal plate as described above, so that the connection described above is not made by welding or brazing, but the three metal parts form a single continuous metal part. Since the linear portions 321 are each connected to the first fixing section 311 and the second fixing section 312, the multiple linear portions 321 are arranged next to each other along the longitudinal direction of the first discharge electrode 134a and the second discharge electrode 134b aligned with the optical axis of the laser light. The width of the gap between the linear portions 321 adjacent to each other ranges, for example, from 19.0 mm to 19.5 mm, and the laser gas can pass through the gap, as shown in FIG. 3.

The linear portions 321 are bent at the portion where they are connected to the first fixing section 311, so that the longitudinal direction of the linear portions 321 is not parallel to the width direction of the first fixing section 311. The linear portions 321 are bent at the portion where they are connected to the second fixing section 312, so that the longitudinal direction of the linear portions 321 is not parallel to the width direction of the second fixing section 312. Furthermore, the width direction of the first fixing section 311 and the width direction of the second fixing section 312 are not parallel to each other and incline with respect to each other by an angle of, for example, approximately 90 degrees.

### 2.2 Operation

The operation of the gas laser apparatus 100 according to Comparative Example will next be described.

In the state before the gas laser apparatus 100 outputs the laser light, the internal spaces of the optical path tubes 147a, 171, and 500 and the internal spaces of the enclosures 145a and 161 are filled with the purge gas from the purge gas supply source, which is not shown. The laser gas is supplied from the laser gas supply source, which is not shown, into the internal space of the discharge chamber 131. When the laser gas is supplied, the laser processor 190 controls the motor 149a to cause it to rotate the crossflow fan 149. The rotation of the crossflow fan 149 causes the laser gas to circulate in the internal space of the discharge chamber 131. In this process, the configuration in which the metal seal 133 prevents formation of a gap between the chamber body 131M and the electrically insulating plate 135 prevents the laser gas from leaking out of the discharge chamber 131.

The crossflow fan 149 circulates the laser gas as indicated by the arrows in FIG. 3. In this process, the laser gas passes through the gaps between the linear portions 321 of the return member 300a provided upstream of the first discharge electrode 134a and the second discharge electrode 134b in the flow of the laser gas. The laser gas then passes through the space between the first discharge electrode 134a and the second discharge electrode 134b, and passes through the gaps between the linear portions 321 of the return member 300b provided downstream of the first discharge electrode 134a and the second discharge electrode 134b in the flow of the laser gas.

When the laser processor 190 receives the signal indicating the target energy Et and the signal indicating the light emission trigger Tr from the exposure processor 230, the gas laser apparatus 100 is controlled to output the laser light. When the laser processor 190 receives the signal indicating the target energy Et, the laser processor 190 closes the shutter 170 and drives the charger 141. The laser processor 190 turns on the switch 151 in the pulse compression circuit 150. As a result, the current from the charger 141 flows to the pulse compression circuit 150, and the pulse-shaped high voltage is applied for a short period to the first discharge electrode 134a via the current introducing terminal 157. Note that the timing at which the high voltage is applied to the space between the preliminary ionization inner electrode 183 and the preliminary ionization outer electrode 185 is slightly earlier than the timing at which the high voltage is applied to the space between the first discharge electrode 134a and the second discharge electrode 134b. When the high voltage is applied to the space between the preliminary ionization inner electrode 183 and the preliminary ionization outer electrode 185, corona discharge occurs in the vicinity of the dielectric pipe 181 and the end of the preliminary ionization outer electrode 185, and ultraviolet light is radiated. When the laser gas between the first discharge electrode 134a and the second discharge electrode 134b is irradiated with the ultraviolet light, the laser gas between the first discharge electrode 134a and the second discharge electrode 134b is preliminarily ionized. After the preliminary ionization, when the high voltage is applied to the space between the first discharge electrode 134a and the second discharge electrode 134b as described above, primary discharge occurs between the first discharge electrode 134a and the second discharge electrode 134b. In this process, the configuration in which the multiple linear portions 321 of the return members 300a and 300b are arranged next to each other along the longitudinal direction of the second discharge electrode 134b suppresses non-uniform primary discharge along the longitudinal direction of the first discharge electrode 134a and the second discharge electrode 134b.

The primary discharge excites the laser medium contained in the laser gas between the first discharge electrode 134a and the second discharge electrode 134b, and when the laser medium transitions back to the ground state, the laser medium emits light. This light resonates between the grating 145c and the output coupling mirror 147, and the light is amplified whenever passing through the discharge space in the internal space of the discharge chamber 131, resulting in laser oscillation. Part of the resonating laser light passes as the pulse laser light through the output coupling mirror 147 and travels to the beam splitter 163.

Part of the laser light having traveled to the beam splitter 163 is reflected off the beam splitter 163 and received by the photosensor 165. The photosensor 165 measures the energy E of the received laser light and outputs the signal representing the energy E to the laser processor 190. The laser processor 190 controls the charging voltage in such a way that a difference ΔE between the energy E and the target energy Et falls within an allowable range, and after the difference ΔE falls within the allowable range, the laser processor 190 transmits a reception preparation completion signal, which indicates that the laser processor 190 is ready to receive the light emission trigger Tr, to the exposure processor 230.

Upon reception of the reception preparation completion signal, the exposure processor 230 transmits the light emission trigger Tr to the laser processor 190. When the laser processor 190 opens the shutter 170 in synchronization with the reception of the light emission trigger Tr, the laser light having passed through the shutter 170 enters the exposure apparatus 200. The laser light is, for example, the pulse laser light having the center wavelength of 193 nm.

### 2.3 Problems

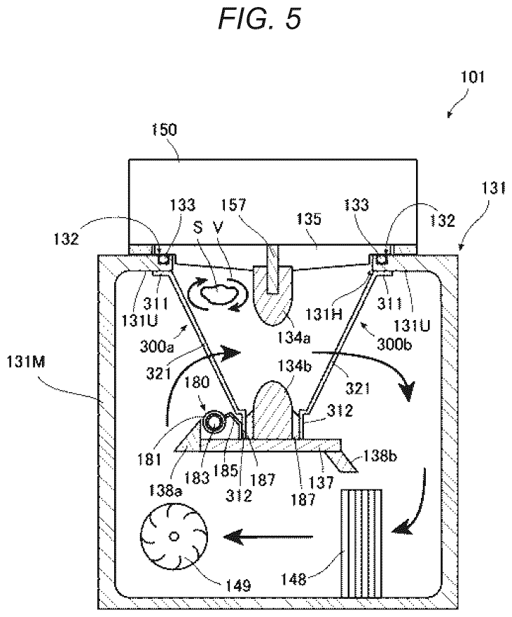

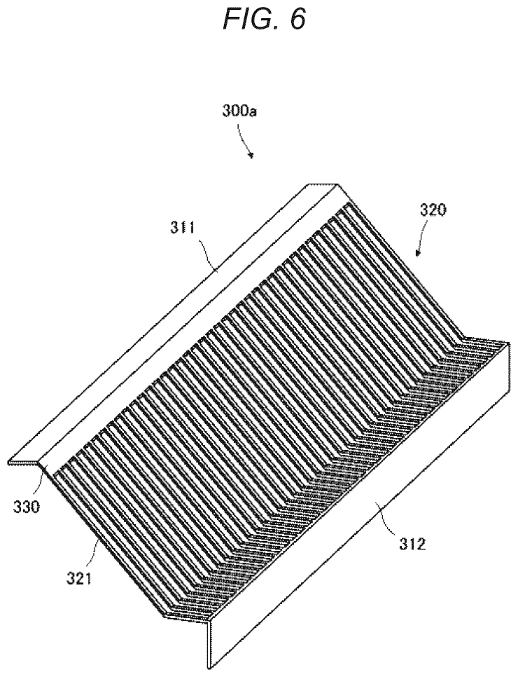

FIG. 5 shows the flow of the laser gas in detail. The first discharge electrode 134a is located in the internal space of the discharge chamber 131. Part of the laser gas therefore does not smoothly flow, and stagnation S or vortices V may occur, as shown in FIG. 5. In this case, part of the laser gas separates from the main part of the laser gas to cause a decrease in the flow rate of the laser gas, so that the primary discharge becomes unstable, and the stability of the laser light output from the gas laser apparatus 100 may therefore deteriorate.

To solve the problem described above, in the following embodiments, a chamber apparatus for a laser 101 and a gas laser apparatus 100 capable of outputting stable laser light are presented by way of example.

### 3. Description of First Embodiment

A chamber apparatus for a laser 101 according to a first embodiment will next be described. Note that the same configurations as those described above have the same reference characters, and duplicate description of the same configurations will be omitted unless otherwise they are particularly described. In addition, in some of the drawings, some of the members are omitted or simplified in some cases, only some of the same elements have the same reference characters, and some other elements do not have reference characters in some cases for clarity.

### 3.1 Configuration

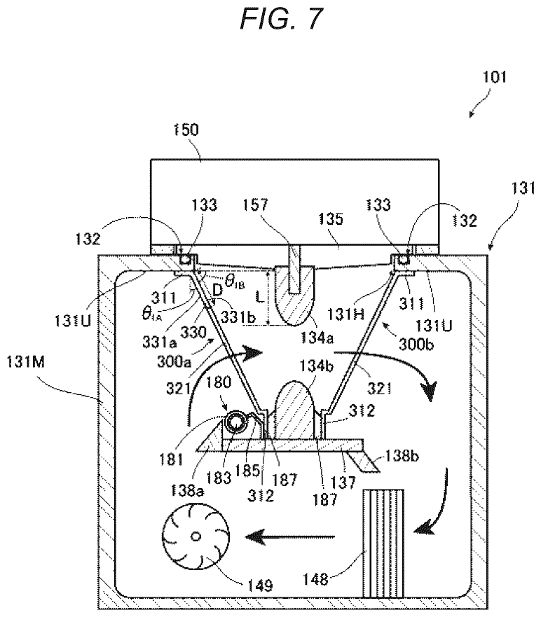

FIG. 6 shows a return member 300a in the present embodiment, and FIG. 7 is a cross-sectional view of the chamber apparatus 101 according to the present embodiment taken along a plane perpendicular to the optical axis of the laser light. The return member 300a in the present embodiment differs from the return member 300a in Comparative Example in that the former includes a plate-shaped section 330, as shown in FIG. 6. Note that the return member 300b is configured in the same manner as in Comparative Example. The plate-shaped section 330 is a flat-plate-shaped member that is provided on a top wall 131U side of the return member 300a and has substantially rectangular principal surfaces 331a and 331b. The principal surface 331a faces an upstream side in the flow of the laser gas, and the principal surface 331b faces a downstream side in the flow of the laser gas. One side surface along the longitudinal direction of the plate-shaped section 330 is connected to the first fixing section 311. The longitudinal direction of the plate-shaped section 330 is therefore aligned with the longitudinal direction of the first discharge electrode 134a. The other side surface along the longitudinal direction of the plate-shaped section 330 is connected to the multiple linear portions 321.

In the present embodiment, the return member 300a is formed by punching and bending a single metallic plate, as in Comparative Example. The plate-shaped section 330 is therefore made of the same material as the return member 300a described in Comparative Example. In addition, a welding mark or a brazing mark is not formed at the portion where the plate-shaped section 330 is connected to the first fixing section 311, and the plate-shaped section 330 is seamlessly connected to the first fixing section 311. The phrase “seamlessly connected” is synonymous with “continuously formed”. In the present embodiment, since the first fixing section 311 is fixed to the top wall 131U as in Comparative Example, the first fixing section 311 can be taken as a connection plate section connected to the top wall 131U. The plate-shaped section 330 is further seamlessly connected to the linear portions 321. Note that FIG. 7 shows the boundary between the plate-shaped section 330 and the linear portions 321 for ease of understanding.

The plate-shaped section 330 is bent at the portion where it is connected to the first fixing section 311, and is inclined such that the further the plate-shaped section 330 is away from the top wall 131U, the more downstream the plate-shaped section 330 is in the flow of the laser gas. As described above, in the present embodiment, since the plate-shaped section 330 has the shape of a flat plate, the direction in which the plate-shaped section 330 inclines is fixed irrespective of the distance from the top wall 131U. The width direction of the plate-shaped section 330 inclines by an angle θ_{1A} with respect to the direction perpendicular to the principal surface of the first fixing section 311, and inclines by an angle θ_{1B} with respect to the width direction of the first fixing section 311. Since the sum of the angles θ_{1A} and θ_{1B} is 90 degrees, θ_{1A} and θ_{1B} are each an acute angle. Any of the following relationships may be satisfied: θ_{1A}<θ_{1B}; θ_{1A}>θ_{1B}; and θ_{1A}=θ_{1B}. Now, let D be the width of the plate-shaped section 330, and L be the vertical distance from the top wall 131U to the lowermost position of the first discharge electrode 134a. Under the definitions described above, Expression (1) below is preferably satisfied.

D×cos θ_{1A}≤L (1)

When Expression (1) is satisfied, the plate-shaped section 330 is hidden behind the first discharge electrode 134a when the first discharge electrode 134a is viewed from the downstream side in the flow of the laser gas along the direction perpendicular to the direction from the first discharge electrode 134a toward the second discharge electrode 134b. Note that, depending on the plate thickness of the plate-shaped section 330, even when Expression (1) is satisfied, the plate-shaped section 330 may be visible below the first discharge electrode 134a only by the amount smaller than the plate thickness of the plate-shaped section 330. However, the state described above is considered as an allowable error, and taken as a state in which the plate-shaped section 330 is hidden behind the first discharge electrode 134a. That is, when Expression (1) is satisfied, it can be said that the plate-shaped section 330 is hidden behind the first discharge electrode 134a.

Note that Expression (2) below may be satisfied.

D×cos θ_{1A}<L (2)

### 3.2 Effects and Advantages

In the chamber apparatus for a laser 101 according to the present embodiment, the return member 300a, which is provided upstream of the second discharge electrode 134b in the flow of the laser gas, includes the ladder section 320 including the multiple linear portions 321 arranged next to each other along the optical axis, and the plate-shaped section 330 provided on the top wall 131U side of the return member 300a, connected to the multiple linear portions 321, and inclined such that the further the plate-shaped section 330 is away from the top wall 131U, the more downstream the plate-shaped section 330 is in the flow of the laser gas. The plate-shaped section 330, which rectifies the laser gas, can prevent stagnation and vortices from occurring in the flow of the laser gas. A decrease in the flow rate of the laser gas is therefore suppressed, so that unstable primary discharge is avoided. The chamber apparatus for a laser 101 according to the present embodiment can therefore output stable laser light. Furthermore, the region around the first discharge electrode 134a is a region where the inductance of a discharge circuit is easily affected so that the potential greatly varies. Therefore, a new member disposed around the first discharge electrode 134a may affect the inductance of the discharge circuit, resulting in a decrease in efficiency. In the present embodiment, however, a portion of the return member 300a having been already disposed serves as the plate-shaped section 330 to rectify the laser gas, so that the situation in which the return member 300a affects the inductance of the discharge circuit can be suppressed as compared with a case where the plate-shaped section 330 is provided at a position separate from the return member 300a. A decrease in efficiency can therefore be suppressed even though the member that rectifies the laser gas is newly disposed.

Furthermore, the return member 300a in the present embodiment is so configured that the direction in which the plate-shaped section 330 inclines is fixed irrespective of the distance from the top wall 131U. The plate-shaped section 330 can therefore be configured with a flat plate, so that the cost of the plate-shaped section 330 can be reduced as compared with a case where the plate-shaped section 330 is bent.

The return member 300a in the present embodiment is further so configured that a side surface of the plate-shaped section 330 is connected to the linear portions 321. The thickness of the return member 300a can therefore be made smaller than when the principal surface 331a or the principal surface 331b of the plate-shaped section 330 is connected to the linear portions 321.

The return member 300a in the present embodiment is so configured that the plate-shaped section 330 is seamlessly connected to the linear portions 321. The plate-shaped section 330 may therefore be formed by punching at the same time when the linear portions 321 are punched. The return member 300a can therefore be manufactured at low cost. In addition, when connection marks such as welding marks or brazing marks remain at the portions where the plate-shaped section 330 is connected to the linear portions 321, the connection marks protrude beyond the linear portions 321 and may become resistance to the flow of the laser gas. However, when there are no seams between the plate-shaped section 330 and the linear portions 321 as in the present embodiment, creation of such resistance can be avoided.

The return member 300a in the present embodiment is so configured that the plate-shaped section 330 is seamlessly connected to the first fixing section 311, which is the connection plate section. The first fixing section 311 and the plate-shaped section 330 can therefore be formed by bending a metal plate including the first fixing section 311 and the plate-shaped section 330. The return member 300a can therefore be manufactured at a lower cost than when the plate-shaped section 330 is welded or brazed to the first fixing section 311.

The return member 300a in the present embodiment is so configured that the plate-shaped section 330 is hidden behind the first discharge electrode 134a when the first discharge electrode 134a is viewed from the downstream side in the flow of the laser gas along the direction perpendicular to the direction from the first discharge electrode 134a toward the second discharge electrode 134b. That is, Expression (1) described above is satisfied. The situation in which the plate-shaped section 330 inhibits the flow of the laser gas can therefore be avoided as compared with a case where the plate-shaped section 330 protrudes beyond the first discharge electrode 134a.

### 4. Description of Second Embodiment

A chamber apparatus for a laser 101 according to a second embodiment will next be described. Note that the same configurations as those described above have the same reference characters, and duplicate description of the same configurations will be omitted unless otherwise they are particularly described. In addition, in some of the drawings, some of the members are omitted or simplified in some cases, only some of the same elements have the same reference characters, and some other elements do not have reference characters in some cases for clarity.

### 4.1 Configuration

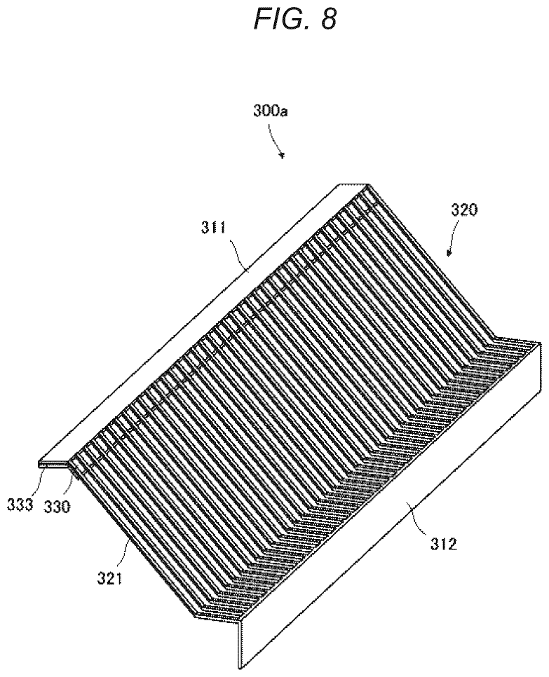

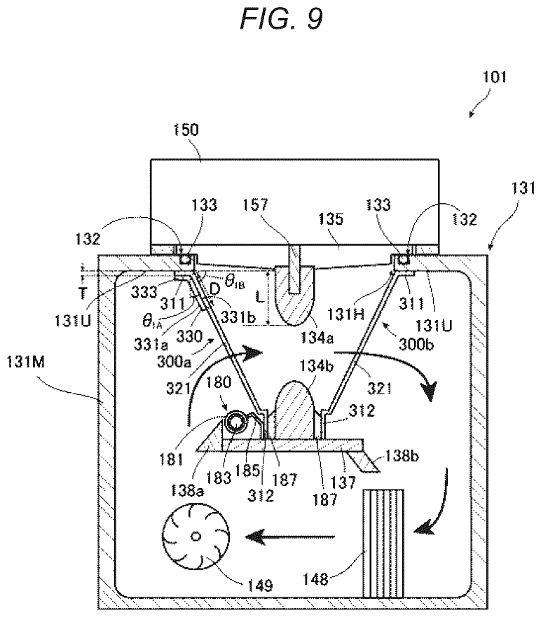

FIG. 8 shows a return member 300a in the present embodiment, and FIG. 9 is a cross-sectional view of the chamber apparatus 101 according to the present embodiment taken along a plane perpendicular to the optical axis of the laser light. The return member 300a in the present embodiment differs from the return member 300a in the first embodiment in that the principal surface 331b of the plate-shaped section 330, which is the principal surface facing the downstream side in the flow of the laser gas, is connected to the linear portions 321, as shown in FIGS. 8 and 9. In the present embodiment, the plate-shaped section 330 is connected to the linear portions 321 by welding or brazing.

Also in the present embodiment, the first fixing section 311 can be taken as the connection plate section connected to the top wall 131U, and in the present embodiment, the linear portions 321 are seamlessly connected to the connection plate section. In the present embodiment, the return member 300a includes a third fixing section 333, which is seamlessly connected to the plate-shaped section 330, and the third fixing section 333 is fixed along with the first fixing section 311 to the top wall 131U.

In the present embodiment, let D be the width of the plate-shaped section 330, and L be the vertical distance from the top wall 131U to the lowermost position of the first discharge electrode 134a. Furthermore, let T be the thickness of the first fixing section 311. In the present embodiment, Expression (3) below is preferably satisfied.

T+D×cos θ_{1A}≤L (3)

When Expression (3) is satisfied, the plate shaped section 330 is hidden behind the first discharge electrode 134a when the first discharge electrode 134a is viewed in the same manner as in the case where Expression (1) is satisfied in the first embodiment. Also in the present embodiment, the error in terms of the visibility of the plate-shaped section 330 is considered in the same manner as in the first embodiment.

Note that Expression (4) below may instead be satisfied.

T+D×cos θ_{1A}<L (4)

### 4.2 Effects and Advantages

In the present embodiment, the downstream principal surface 331b of the plate-shaped section 330 is connected to the linear portions 321. Thus, the plate-shaped section 330 only needs to be connected to the return member 300a in Comparative Example. The linear portions 321 can thus be retrofitted. Furthermore, since the ladder section 320 and the plate-shaped section 330 can be formed separately, the degree of freedom in manufacturing the return member 300a can be improved. Moreover, since the principal surface connected to the linear portions 321 is the downstream principal surface, there is no unevenness on the upstream side, so that the resistance to the flow of the laser gas can be suppressed.

### 4.3 Variations

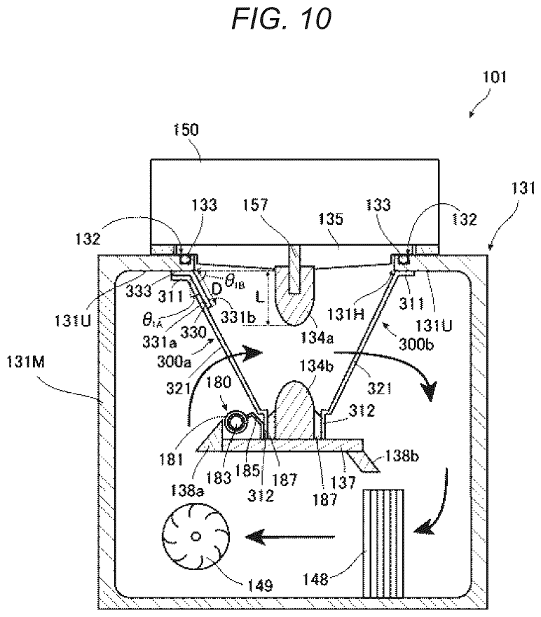

A variation of the present embodiment will next be described. FIG. 10 is a cross-sectional view of a chamber apparatus 101 according to the variation of the present embodiment taken along a plane perpendicular to the optical axis of the laser light. A return member 300a in the present variation differs from the return member 300a in the second embodiment in that the principal surface 331a of the plate-shaped section 330, which is the principal surface facing the upstream side in the flow of the laser gas, is connected to the linear portions 321, as shown in FIG. 10. Therefore, in the present variation, since the third fixing section 333 is fixed to the top wall 131U, the third fixing section 333 can be taken as the connection plate section connected to the top wall 131U, and in the present variation, the plate-shaped section 330 is seamlessly connected to the connection plate section.

In the present variation, in which Expression (1) is satisfied as in the first embodiment, the plate-shaped section 330 is hidden behind the first discharge electrode 134a when the first discharge electrode 134a is viewed as in the first embodiment. Expression (2) may instead be satisfied.

In the present variation, since the upstream principal surface 331a of the plate-shaped section 330 is connected to the linear portions 321, the plate-shaped section 330 reinforces the linear portions 321 against the wind pressure acting in the gas flow direction, so that the rigidity of the return member 300a can be improved.

### 5. Description of Third Embodiment

A chamber apparatus for a laser 101 according to a third embodiment will next be described. Note that the same configurations as those described above have the same reference characters, and duplicate description of the same configurations will be omitted unless otherwise they are particularly described. In addition, in some of the drawings, some of the members are omitted or simplified in some cases, only some of the same elements have the same reference characters, and some other elements do not have reference characters in some cases for clarity.

### 5.1 Configuration

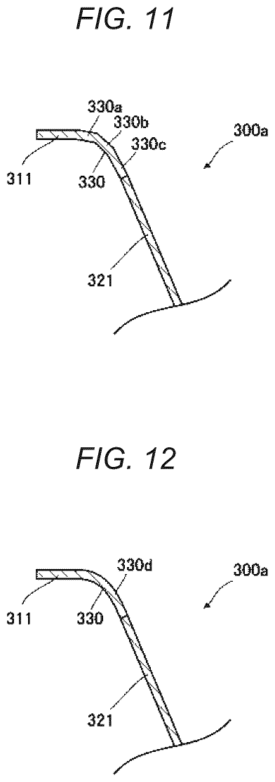

FIG. 11 is a cross-sectional view showing a return member 300a according to the present embodiment. The return member 300a in the present embodiment differs from the return member 300a in the first embodiment in that the further a plate-shaped section 330 is away from the top wall 131U, the closer an inclination direction of the plate-shaped section 330 is to a direction from the first discharge electrode 134a toward the second discharge electrode 134b. In the present embodiment, the plate-shaped section 330 includes multiple flat plate portions 330a, 330b, and 330c. In the present embodiment, the entire plate-shaped section 330 is configured with the multiple flat plate portions 330a to 330c. The flat plate portions 330a, 330b, and 330c are separate from the top wall 131U in this order, and the inclination directions of the three plate portions are closer to the direction from the first discharge electrode 134a toward the second discharge electrode 134b in this order. The flat plate portions 330a to 330c are each formed by bending a metallic flat plate. Therefore, the flat plate portion 330a is seamlessly connected to the flat plate portion 330b, and the flat plate portion 330b is seamlessly connected to the flat plate portion 330c.

A side surface of the flat plate portion 330a that is the side surface opposite to the flat plate portion 330b is a side surface of the plate-shaped section 330, and is connected to the first fixing section 311, as in the first embodiment. A side surface of the flat plate portion 330c that is the side surface opposite to the flat plate portion 330b is a side surface of the plate-shaped section 330, and is connected to the linear portions 321, as in the first embodiment.

Also in the present embodiment, it is preferable that the plate-shaped section 330 is hidden behind the first discharge electrode 134a when the first discharge electrode 134a is viewed as in the first embodiment. The width and the inclination of each of the flat plate portions 330a, 330b, and 330c are thus set.

Note that in the present embodiment, the number of flat plate portions is three, but the number of the multiple flat plate portions is not particularly limited to a specific number, and may be two or four or more.

### 5.2 Effects and Advantages

The return member 300a in the present embodiment is so configured that the further the plate-shaped section 330 is away from the top wall 131U, the closer the inclination direction of the plate-shaped section 330 is to the direction from the first discharge electrode 134a toward the second discharge electrode 134b. The flow of the laser gas can therefore be changed stepwise as compared with the return member 300a in the first embodiment. The flow of the laser gas can therefore be rectified with higher precision.

### 5.3 Variations

A variation of the present embodiment will next be described. FIG. 12 is a cross-sectional view showing a return member 300a according to the present variation. The return member 300a in the present variation differs from that in the third embodiment in that the former includes a curved plate section 330d, which inclines in a gradually changing direction. In the present example, the entire plate-shaped section 330 is configured with the curved plate section 330d. Since the plate-shaped section 330 has such a configuration, the further the plate-shaped section 330 is away from the top plate 131U, the gradually closer the inclination direction of the plate-shaped section 330 is to the direction from the first discharge electrode 134a toward the second discharge electrode 134b. The flow of the laser gas can therefore be gradually changed. The flow of the laser gas can thus be rectified with higher precision than the flow of the laser gas rectified by the return member 300a in the third embodiment.

Note that the plate-shaped section 330 in the second embodiment and the plate-shaped section 330 in the variation of the second embodiment may each include the multiple flat plate portions 330a, 330b, and 330c as the plate-shaped section 330 in the present embodiment, or may each include the curved plate section 330d as the plate-shaped section 330 in the variation of the present embodiment.

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious for those skilled in the art that embodiments of the present disclosure would be appropriately combined. The terms used throughout the present specification and the appended claims should be interpreted as non-limiting terms. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more”. Further, “at least one of A, B, and C” should be interpreted to mean any of A, B, C, A+B, A+C, B+C, and A+B+C as well as to include combinations of any thereof and any other than A, B, and C.

What is claimed is:

1. A chamber apparatus for a laser, the chamber apparatus being configured to output laser light by exciting a laser gas with an aid of discharge, the chamber apparatus comprising:
a chamber including an electrically conductive chamber body having an opening provided at a top wall of the chamber body, and an insulating plate that closes the opening, the chamber having an internal space filled with the laser gas;
a first discharge electrode disposed on an internal space side of the insulating plate;
a second discharge electrode disposed so as to face the first discharge electrode in the internal space;
a fan configured to cause the laser gas to flow between the first discharge electrode and the second discharge electrode in a direction perpendicular to an optical axis of the laser light; and
a return member provided upstream of the second discharge electrode in a flow of the laser gas, the return member electrically connecting the second discharge electrode to the chamber body, the return member having an end opposite to the second discharge electrode and connected to the top wall,
the return member including a ladder section including multiple linear portions arranged next to each other along the optical axis, and a plate-shaped section provided on a top wall side of the return member, the plate-shaped section being connected to the multiple linear portions, the plate-shaped section being inclined such that the further the plate-shaped section is away from the top wall, the more downstream the plate-shaped section is in the flow of the laser gas.

2. The chamber apparatus for a laser according to claim 1, wherein
the further the plate-shaped section is away from the top plate, the closer an inclination direction of the plate-shaped section is to a direction from the first discharge electrode toward the second discharge electrode.

3. The chamber apparatus for a laser according to claim 2, wherein
the plate-shaped section includes multiple flat plate portions that incline in directions different from each other and are connected to each other.

4. The chamber apparatus for a laser according to claim 2, wherein
the plate-shaped section includes a curved plate section that inclines in a gradually changing direction.

5. The chamber apparatus for a laser according to claim 1, wherein
the direction in which the plate-shaped section inclines is fixed irrespective of a distance from the top wall.

6. The chamber apparatus for a laser according to claim 1, wherein
a side surface of the plate-shaped section is connected to the linear portions.

7. The chamber apparatus for a laser according to claim 6, wherein
the plate-shaped section is seamlessly connected to the linear portions.

8. The chamber apparatus for a laser according to claim 6, wherein
the return member includes a connection plate section connected to the top wall, and
the plate-shaped section is seamlessly connected to the connection plate section.

9. The chamber apparatus for a laser according to claim 1, wherein
a principal surface of the plate-shaped section is connected to the linear portions.

10. The chamber apparatus for a laser according to claim 9, wherein
the principal surface is a principal surface facing a downstream side in the flow of the laser gas.

11. The chamber apparatus for a laser according to claim 10, wherein
the return member includes a connection plate section connected to the top wall, and
the linear portions are seamlessly connected to the connection plate section.

12. The chamber apparatus for a laser according to claim 9, wherein
the principal surface is a principal surface facing an upstream side in the flow of the laser gas.

13. The chamber apparatus for a laser according to claim 12, wherein
the return member includes a connection plate section connected to the top wall, and
the plate-shaped section is seamlessly connected to the connection plate section.

14. The chamber apparatus for a laser according to claim 1, wherein
the plate-shaped section is hidden behind the first discharge electrode when the first discharge electrode is viewed from a downstream side in the flow of the laser gas along a direction perpendicular to a direction from the first discharge electrode toward the second discharge electrode.

15. A gas laser apparatus comprising a chamber apparatus for a laser, the chamber apparatus being configured to output laser light by exciting a laser gas with an aid of discharge, the chamber apparatus for a laser including
a chamber including an electrically conductive chamber body having an opening provided at a top wall of the chamber body, and an insulating plate that closes the opening, the chamber having an internal space filled with the laser gas,
a first discharge electrode disposed on an internal space side of the insulating plate,
a second discharge electrode disposed so as to face the first discharge electrode in the internal space,
a fan configured to cause the laser gas to flow between the first discharge electrode and the second discharge electrode in a direction perpendicular to an optical axis of the laser light, and
a return member provided upstream of the second discharge electrode in a flow of the laser gas, the return member electrically connecting the second discharge electrode to the chamber body, the return member having an end opposite to the second discharge electrode and connected to the top wall,
the return member including a ladder section including multiple linear portions arranged next to each other along the optical axis, and a plate-shaped section provided on a top wall side of the return member, the plate-shaped section being connected to the multiple linear portions, the plate-shaped section being inclined such that the further the plate-shaped section is away from the top wall, the more downstream the plate-shaped section is in the flow of the laser gas.

16. An electronic device manufacturing method comprising:
generating laser light by using a gas laser apparatus including a chamber apparatus for a laser, the chamber apparatus being configured to output the laser light by exciting a laser gas with an aid of discharge;
outputting the laser light to an exposure apparatus; and
exposing a photosensitive substrate to the laser light in the exposure apparatus to manufacture electronic devices,
the chamber apparatus for a laser including
a chamber including an electrically conductive chamber body having an opening provided at a top wall of the chamber body, and an insulating plate that closes the opening, the chamber having an internal space filled with the laser gas,
a first discharge electrode disposed on an internal space side of the insulating plate,
a second discharge electrode disposed so as to face the first discharge electrode in the internal space,
a fan configured to cause the laser gas to flow between the first discharge electrode and the second discharge electrode in a direction perpendicular to an optical axis of the laser light, and
a return member provided upstream of the second discharge electrode in a flow of the laser gas, the return member electrically connecting the second discharge electrode to the chamber body, the return member having an end opposite to the second discharge electrode and connected to the top wall,
the return member including a ladder section including multiple linear portions arranged next to each other along the optical axis, and a plate-shaped section provided on a top wall side of the return member, the plate-shaped section being connected to the multiple linear portions, the plate-shaped section being inclined such that the further the plate-shaped section is away from the top wall, the more downstream the plate-shaped section is in the flow of the laser gas.
